(19) United States
(12) Patent Application Publication
(10) Pub. No.: US 2008/0240452 A1
(43) Pub. Date: Oct. 2, 2008

(54) At-Home Hearing Aid Tester and Method of Operating Same

(76) Inventors: Mark Burrows, Princeton, NJ (US); John Cronin, Jericho, VT (US); Tushar Narsana, Winooski, VT (US); Steven A. Shaya, Highlands, NJ (US); John Anthony Singarayar, Skillman, NJ (US)

Correspondence Address: MCCARTER & ENGLISH, LLP, FOUR GATEWAY CENTER, 100 MULBERRY STREET, NEWARK, NJ, 07102, US

(21) Appl. No.: 11/570,478

(22) PCT Filed: Jun. 10, 2005
(86) PCT No.: PCT/US05/20472

§ 371 Date: Oct. 31, 2007

Related U.S. Application Data
(60) Provisional application No. 60/579,220, filed on Jun. 14, 2004.
(60) Provisional application No. 60/579,479, filed on Jun. 14, 2004.

(51) Int. Cl. H04R 29/00

(52) U.S. Cl. 381/60

(57) ABSTRACT

The present invention is an apparatus for and method of remotely, automatically, and routinely conducting diagnostic testing on a programmable hearing aid to ensure that it is functioning as intended when optimized for an individual's needs and preferences. Because hearing aids deteriorate with time and buildup of earwax, individuals can be uncertain whether their hearing is worsening or the hearing aid is malfunctioning. The net effect is diminished hearing aid performance—and thus diminished quality of life. The present invention tests the hearing aid for proper function as frequently as daily.

### CROSS REFERENCE TO RELATED APPLICATION

This application claims the benefit of U.S. Provisional Application Nos. 60/579,220 filed Jun. 14, 2004 and 60/579,479 filed Jun. 14, 2004, assigned to the assignee of this application and incorporated by reference herein.

### FIELD OF THE INVENTION

The present invention relates to hearing aids, specifically to a method of and apparatus for automatically testing an individual's hearing aid in the individual's home as frequently as daily in order to determine whether the hearing aid needs to be cleaned or serviced.

### BACKGROUND OF THE INVENTION

About two million hearing aids are sold annually in the U.S., generating $2.6 billion in revenue. Although 28 million Americans are hearing impaired, only six million use hearing aids. Year after year, market penetration has increased little, making it apparent that factors other than user need have inhibited market penetration of hearing aids. Central among these factors is the product-centric (as opposed to patient-centric) approach that the hearing aid industry has taken to fitting hearing aids. Hearing aid manufacturers concentrate efforts almost solely on improving their devices, most notably with digital signal processing's (DSP), while other patient needs and preferences are virtually ignored. Resources have not gone to improving the consequently ponderous process which patients face in purchasing, using, and maintaining a hearing aid.

The anatomy of the ear canal includes ceruminous glands that secrete a yellowish, wax-like substance called cerumen (earwax), which accumulates in the ear canal. Due to both the action of cilia located in the ear canal and the natural movements of the ear canal, the cerumen gradually migrates outward. When a hearing aid is inserted into the ear canal, it is susceptible to the effects of cerumen accumulation and migration. Cerumen often mixes with sloughed off skin and dirt, further impairing the performance of the hearing aid.

Acoustic speakers in most modern hearing aids are particularly susceptible to performance problems and damage from cerumen accumulation; initially, cerumen blocks the speaker port, occluding the acoustic path, in turn preventing sound waves from reaching the tympanic membrane. Eventually, the cerumen can penetrate the receiver housing, damaging the sensitive mechanical and electrical components whose failure necessitates repair or replacement of the hearing aid. Not only is the cost in time and money significant, but also individuals are uncertain whether their hearing is worsening or the hearing aid is malfunctioning. The net effect is diminished hearing-aid performance—and thus a diminished quality of life.

U.S. Pat. No. 6,349,790, entitled, “Self-cleaning cerumen guard for a hearing device,” assigned to Sonic Innovations and incorporated by reference herein, describes a thermally activated cleaning element on the distal end of a hearing aid adjacent to the speaker, which retracts when heated by the inner ear to body temperature, then extends when cooled to room temperature. Upon removal of the hearing aid from the ear, the self-cleaning cerumen guard automatically removes any debris that has accumulated in the speaker port.

U.S. Pat. No. 5,401,920, entitled, “Cerumen filter for hearing aids,” and incorporated by reference herein, discloses a replaceable and disposable wax guard that is affixed over the sound port of an in-the-ear hearing aid by means of a pressure sensitive tape. The filter itself is porous to sounds but is receptive to cerumen. While providing some level of protection against cerumen damage to the internal components of the hearing device, this and other similar types of filters become quickly soiled, resulting in poor device performance due to a blocked speaker port. As such, the user must frequently replace the disposable filter. The small size of these devices often requires a high level of visual acuity and dexterity for such maintenance.

U.S. Pat. No. 5,327,500, entitled “Cerumen barrier for custom in the ear type hearing instruments,” and incorporated by reference herein, discloses a cerumen barrier for a custom, in-the-ear hearing aid. The cerumen barrier consists of a small door covering the receiver port that can be manually rotated open to provide cleaning under the door and around the receiver port. While also providing some level of protection against cerumen to the internal components of the hearing aid, significant user intervention is relied on to clean the filter.

With the exception of the '790, the hearing aid devices from the prior art have a profound shortcoming of relying upon the hearing aid user to remember to periodically clear the cerumen that has accumulated on the device. Yet hearing aid users are no different from consumers of other products: all want convenience. Cleaning a hearing aid is one more thing to remember, so it is not done faithfully. This issue has become even more important as hearing aids have gotten smaller. Primarily to overcome the stigma of wearing a hearing aid, manufacturers have miniaturized hearing aids to the point that completely-in-canal (CIC) hearing aids reside out of sight deep in the ear canal, proximate to the tympanic membrane (eardrum). This placement provides the overriding benefits of improving frequency response, reducing distortion due to jaw extrusion, and improving overall sound fidelity; however, it worsens the problem of earwax buildup.

When users are unsure of or unhappy with their hearing aid's performance, they must bear the inconvenience and cost of taking it to their audiologist for assessment and adjustment. There is currently no way for users to test and calibrate their hearing aids to manufacturers' standards, ensuring optimal hearing aid performance, from the convenience of their homes. Moreover, no automatic tests, i.e., tests that do not require the hearing aid users' manual intervention, exist today.

U.S. Pat. No. 6,379,314, entitled, “Internet system for testing hearing,” assigned to Health Performance, Inc and incorporated by reference herein, relates to a computer system that is accessible to a community of users for self-administered hearing tests over the Internet, which is a significant improvement to conventional hearing testing that requires sophisticated equipment at dedicated hearing and health centers by experienced personnel. Such automatic audiometers are becoming widely accepted in hearing screening applications such as in schools and industrial clinics. This automated approach results in minimal operator involvement, faster testing, and improved accuracy.

U.S. Pat. No. 4,284,847, entitled, “Audiometric testing, analyzing, and recording apparatus and method,” and incorporated by reference herein, discloses a microprocessor-based audiometry apparatus that includes tone-generation means at variable frequency and intensities, memory for software, and patient-data storage. The apparatus is capable of being networked with remote computers for data transfer. One of the main features of the '847 patent is its ability to compare recent audiogram data with previously acquired ones, and then automatically compute such changes as hearing threshold shifts.

U.S. Pat. No. 6,411,678, entitled, “Internet based remote diagnostic system,” assigned to General Electric Company and incorporated by reference herein, discloses a remote diagnostic communication system that uses a public or private remote access infrastructure to facilitate wide-area communications between the remote site and the diagnostic center and that requires only local telephone calls. The diagnostic center and one or more remote sites at which monitored equipment is located are coupled to a wide area network (WAN). When data are to be transferred from a remote site to the central diagnostic center, the remote site initiates a local telephone call to a point-of-presence (POP) server on the WAN backbone. This could be an Internet service provider (ISP) in the case of the Internet, or an intranet POP server in the case of a private network. Data is then transferred to a computer in the POP server or anywhere on the network, as long as it is outside the “firewall” electronically isolating the diagnostic center from unwanted communications. To complete the transfer, the diagnostic center transfers the data from the POP server to the diagnostic center via the public or private wide-area network (the Internet or an intranet). The data transfer can take place either on a scheduled basis, or when an alarm condition is detected at the remote site. The central diagnostic center can prompt the remote site to connect to the POP server via a wireless paging service or a direct-dial phone call.

The '314 demonstrates a means for conducting automatic hearing tests over the Internet while the '687 patent discloses remote diagnostic testing of electronic equipment over the Internet, either on demand or as scheduled. The prior art, however, does not combine these means in a manner that provides a remote diagnostic hearing aid test, much less an automated one, that doesn't rely on the faithful and concerted efforts of patients.

### SUMMARY OF THE INVENTION

It is therefore an object of the present invention to simplify the process of diagnostic testing and maintaining hearing aids, so that the hearing aid testing can be done in a more convenient location for the user, such as the user's home.

It is another object of the present invention to provide automatic, convenient, at-home remote diagnostic testing of a hearing aid that can be performed as frequently as daily and that can signal hearing aid status updates, such as improper functioning or the need for service.

The present invention is an at-home hearing aid tester apparatus and method of operating the tester, which can be performed as frequently as daily. An individual places the hearing aid in a small countertop device at regular intervals, such as at the end of each day; the device can test the audio frequency range for which the hearing aid is designed and for which the device is soundproof. The device tests the hearing aid for proper function by pinging it with a series of audio waves, after which the device signals the individual as appropriate of such status as improper function, service required, etc. Additionally, the apparatus may be connected via Internet or other network connectivity to a central computer that remotely further diagnoses the hearing aid. The device may also issue a series of corrective tones (if the hearing aid is programmable) to provide some degree of servicing, for instance, adding amplification in response to the hearing aid's normal degradation over time. This networking capability also enables continuous updating of an individual's file on the central computer, for reference and analysis by audiologists and other stakeholders for ways to continually improve the individual's hearing.

Thus, the present invention provides for a portable hearing aid testing apparatus comprising:

a resealable housing defining a cavity for receiving a hearing aid, wherein the cavity includes a microphone and has a configuration for securing the hearing aid in a position where a speaker of the hearing aid is opposite of the microphone;

communications interface means for coupling to a data signal connection means of the hearing aid; and

a controller coupled to the communications interface means, the microphone and an indicia output means (e.g., indicator light), wherein the controller is operable for testing the operation of the hearing aid.

In a further preferred embodiment, the testing of operation of the hearing aid by the controller comprises:

transmitting testing data from the controller (e.g., directly to the hearing aid or to a speaker within the cavity) to cause the hearing aid to generate sound output;

receiving the hearing aid sound output at the microphone and forwarding sound data signals representative of the sound output to the controller;

evaluating the sound signals to determine whether frequencies and amplitudes of the sound signals correspond to respective expected frequencies and amplitudes associated with the testing data; and

generating a selected indicia (e.g., pass, fail, clean hearing aid) for output at the indicia output means based on the evaluation.

In a further preferred embodiment, the apparatus includes a communications network interface coupled to the controller and for receiving hearing aid testing and programming data from and transmitting user hearing aid profile data to a remote hearing health database, wherein the controller includes a memory for storing the hearing aid programming data and the hearing aid testing data received at the network interface.

In still another preferred embodiment, the hearing aid is programmable based on receipt of a corrective sound signal and the controller, based on the hearing aid programming data received from the health database, causes the speaker to generate the corrective sound signal.

### BRIEF DESCRIPTION OF THE DRAWINGS

Other objects and advantages of the present invention will be apparent from the following detailed description of the presently preferred embodiments, which description should be considered in conjunction with the accompanying drawings in which like references indicate similar elements and in which:

FIG. 1A is a block diagram illustrating the basic operation of a hearing aid that is programmable by a serial interface.

FIG. 1B is a block diagram illustrating a serial interface for programming a hearing aid.

FIG. 2 is a device for in-home, routine, automatic diagnostic testing of a hearing aid.

FIG. 3 is a method of conducting a routine automatic diagnostic test using the apparatus of the present invention with tones and other test data generated by the tester.

FIG. 4 is a method of conducting a routine automatic diagnostic test using the apparatus of the present invention with tones and other test data generated by the hearing aid.

FIG. 5 is a block diagram of the interface between an in-home, routine, diagnostic tester and a hearing aid.

### DETAILED DESCRIPTION OF THE INVENTION

Description of the Prior Art

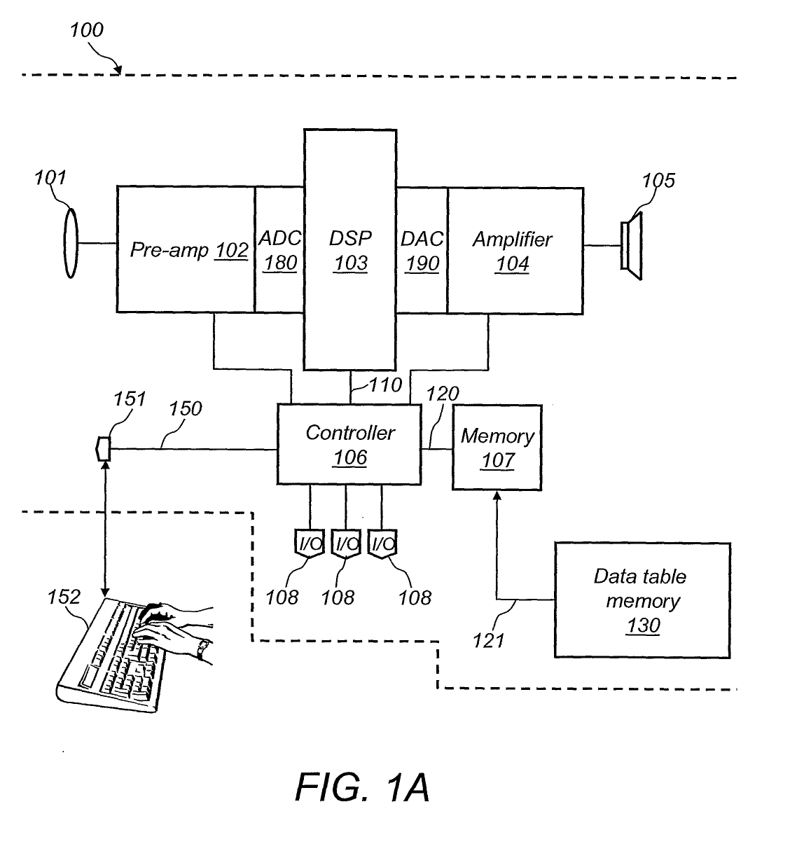

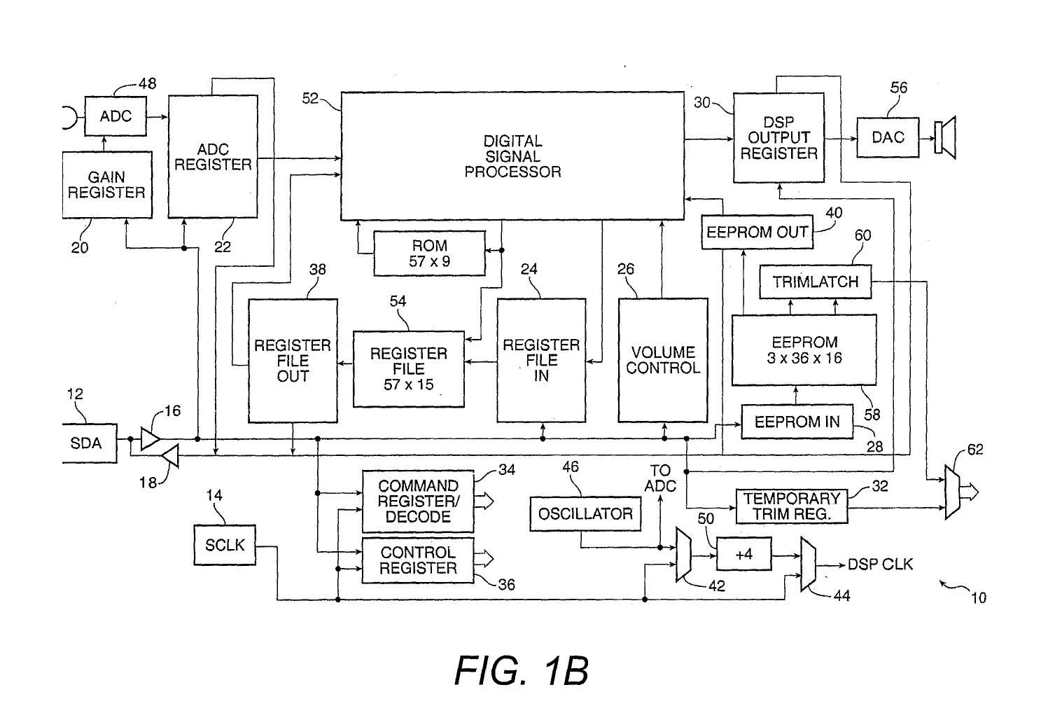

FIG. 1A is a block diagram illustrating the components of a basic hearing aid 100, and basic operation of a programmable hearing aid, which is programmable by a serial interface in order to be optimized for an individual patient's hearing needs and preferences.

Hearing aid 100 consists of the following conventional components: a microphone 101, a pre-amplifier (pre-amp) 102, an analog-to-digital converter (ADC) 180, a digital signal processor (DSP) 103, a digital-to-analog converter (DAC) 190, an amplifier 104, an output speaker 105, a data table memory 130, an address and data bus 121, a memory 107, a controller 106, an address and data bus 120, an address and data bus 110, a plurality of input/output devices (I/O) 108, a programming connection 150, a socket connector 151, and a computer 152.

With hearing aid 100 in a user's ear, sound is collected as an analog signal in microphone 101. This signal is amplified using pre-amp 102, is converted from analog to digital in ADC 180, and then is processed by DSP 103 to meet the individual's unique requirements. The signal from DSP 103 is then converted from digital to analog using DAC 190. This analog signal is then amplified using amplifier 104 for transmission to output speaker 105. Microphone 101 and output speaker 105 have adjustable variable settings to control the input/output volume of sound to hearing aid 100.

A means of programming DSP 103 in order to optimize basic hearing aid 100 for an individual is described in U.S. Pat. No. 6,201,875, entitled, “Hearing aid fitting system,” assigned to Sonic Innovations, Inc. Programming DSP 103 requires that an individual's specific hearing compensation requirements data, like amplitude versus frequency, be loaded from data table memory 130 via address and data bus 121 to memory 107 (such as an EEPROM). Controller 106 then accesses memory 107 via address and data bus 120 to load the hearing compensation requirements data onto DSP 103 via address and data bus 110. I/O 108, such as on/off, volume, and squelch, connected to controller 106 provide individuals with a degree of external control of hearing aid 100.

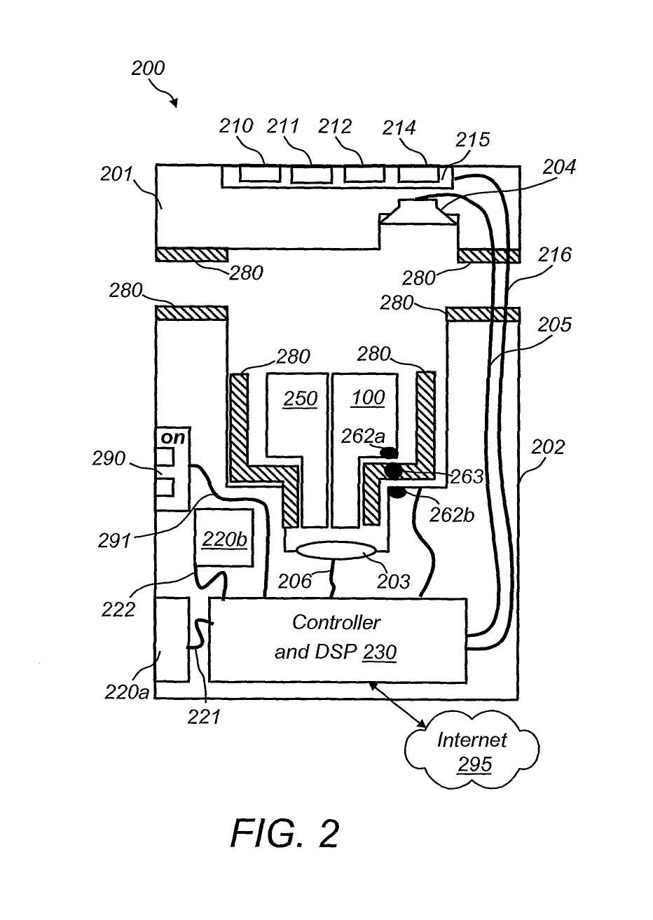

Computer 152 is an external circuit that can be used to program basic hearing aid 100 via socket connector 151, which allows for external communication, and programming connection 150, which allows for a serial or parallel input. U.S. Pat. No. 6,319,020, entitled, “Programming connector for hearing devices,” assigned to Sonic Innovations, Inc., further describes the connections of a programmable hearing aid device. Building a serial interface for programming a hearing aid is also described in U.S. Pat. No. 6,240,193, entitled, “Two-line variable word length serial interface,” assigned to Sonic Innovations, Inc., and is briefly described below in FIG. 2.

In operation, controller 106 gets programmed data from data table memory 130 and loads it into memory 107. The programmed data is then used by DSP 103 when signals go through microphone 101 and pre-amp 102 to ADC 180. After DSP 103 operates on the input signal, DSP 103 outputs the modified and processed signal to DAC 190 and then to amplifier 104 to output speaker 105 of hearing aid 100. Controller 106 uses address and data buses 110, 120 and 121 to move data from DSP 103 as needed. Controller 106 also provides connection to I/O 108 on/off, volume, or squelch external adjusters. In addition, controller 106 connects to programming connection 150, in which socket connector 151 allows communication with an external circuit, such as computer 152, allowing a user to program or direct controller 106.

FIG. 1B illustrates a prior art serial interface for programming a hearing aid, as described in U.S. Pat. No. 6,240,193, “Two-line variable word length serial interface,” assigned to Sonic Innovations, Inc. FIG. 1B is a block diagram of a digital programmable hearing aid 10 (e.g., basic hearing aid 100 of FIG. 1A). including the serial interface. In the serial interface circuit, an SDA pin 12 and an SCLK pin 14 are depicted, while the pins for power and ground are omitted for simplicity's sake. SDA pin 12 is connected to the input of an input buffer 16, and to the output of an output buffer 18. Input buffer 16 is connected to a gain register 20, an ADC register 22, a register file input buffer register 24, a volume control register 26, an EEPROM input buffer register 28, a DSP output register 30, a temporary trim register 32, a command register 34, and a control register 36. Control register 36 includes a latch (not shown). Output buffer 18 is connected to ADC register 22, a register file output buffer register 38, an EEPROM output buffer register 40, and DSP output register 30.

SCLK pin 14 is connected to command register 34, control register 36, a first two-input multiplexer 42, and a second two-input multiplexer 44. An internal oscillator 46 is connected to a second input of first two-input multiplexer 42 and also provides a clock to an ADC 48 (i.e., ADC 180 of FIG. 1A). During normal operation of hearing aid 10, the input of ADC 48 is connected to the electrical input to hearing aid 10. The output of ADC 48 is connected to ADC register 22. The output of first two-input multiplexer 42 is connected to the input of a divide-by-four circuit 50. The output of divide-by-four circuit 50 is connected to the second input of second two-input multiplexer 44. The output of second two-input multiplexer 44 provides a clock to a DSP 52 (i.e., DSP 103 of FIG. 1A).

The output of register file input buffer register 24 is connected to a register file 54, and the output of register file 54 is connected to the input of register file output buffer register 38. The output of DSP output register 30 is connected to a DAC 56 (i.e., DAC 190 of FIG. 1A). The output of EEPROM input buffer register 28 is connected to an EEPROM 58, and the output of EEPROM 58 is connected to the input of EEPROM output buffer register 40 and a trim latch 60. The output of trim latch 60 is connected to a third two-input multiplexer 62, and the second input of third two-input multiplexer 62 is connected to the output of temporary trim register 32. The output of third two-input multiplexer 62 provides trim signals to various circuits in hearing aid 10.

In the serial interface, SDA pin 12 is employed to input a serial data stream including various read and write instructions (described below) from the HI-PRO or external device to hearing aid 10 and to output data from hearing aid 10 both during testing and in the fitting process to determine whether the data in hearing aid 10 is as expected. SCLK pin 14 is used to input a serial clock that clocks in the instructions from the serial data input stream on SDA pin 12.

The present maximum clock rate from the HI-PRO device to the serial interface circuit is 7 kHz. It is anticipated, however, that the serial interface circuit will also interface to other devices such as IC testers, and as a result, the SDA and SCLK signals can operate at 1.5 MHz when receiving data from an external source. The serial interface circuit can drive output through SDA pin 12 having a 50-pf load at a 500 kHz clock rate.

### DESCRIPTION OF THE INVENTION

FIG. 2 is a test device 200 for at-home routine automatic diagnostic testing of a hearing aid, such as basic hearing aid 100 of FIG. 1A. Test device 200 is composed of a top 201 and a base 202. Included is a microphone 203 that captures test tones processed by hearing aid 100 and sends the tones via a connection 206 to a controller and DSP 230. Controller and DSP 230 sends test tones via a speaker connection 205 to a speaker 204, which plays the tones so that they are received by microphone 101 of basic hearing aid 100. Controller and DSP 230 can also send tones to switch on/off basic hearing aid 100.

A plurality of indicator lights 210, 211, 212 and 214 in a light panel 215 are connected by a connector 216 to controller and DSP 230 and signal such messages as “Power on,” “Service hearing aid,” “Passed test,” etc., as appropriate to the diagnostic test results. A means for either AC power 220a or DC power 220b is connected to test device 200 by either a connection 221 or a connection 222, respectively.

An on/off switch 290 is used to turn test device 200 on and off, sending a signal through connector 291 to controller and DSP 230. An adapter 250 may be used to ensure the proper physical fit of hearing aid 100 in proximity to microphone 203.

A serial connector 262a within hearing aid 100 connects hearing aid 100 to a serial connector 262b on test device 200 for diagnostic testing. An optional adapter serial connector 263 connects serial connectors 262a and 262b when optional adapter 250 is used. A quantity of soundproofing 280 is provided to ensure sound tightness, preventing ambient noise from interfering with diagnostic testing.

The Internet 295 represents the capability to connect to the Internet, an intranet, or other similar network, in order to download test programs, ANSI calibration standards, and the like, and to upload test results to a central database for reference and analysis of patient files.

In operation, top 201 is opened, hearing aid 100 (which has DSP 103 preprogrammed based upon a hearing test at the audiologist) is powered on and fit in base 202, positioned above microphone 203 (optionally using adapter 250, which provides the ability to fit many different sizes of hearing aids 100 in standard sized test device 200). Test device 200 is closed and soundproofing 280 ensures that test device 200 is soundproofed.

On/off switch 290 is used to turn test device 200 on, and includes an indicator that indicates that test device 200 is switched on.

Controller and DSP 230 controls the entire electronic operation of test device 200. Controller and DSP 230 has been loaded with information about the user's specific hearing test results so that it may uniquely test that user's hearing aid 100. Controller and DSP 230 draws power from either AC power 220a or DC power 220b.

Controller and DSP 230 may download current data and programs from a remote location via Internet 295. Controller and DSP 230 can program hearing aid 100 through serial connector 262a, which connects hearing aid 100 to serial connector 262b on test device 200 for diagnostic testing. Optional adapter serial connector 263 connects serial connectors 262a and 262b when optional adapter 250 is used. Controller and DSP 230 can erase and rewrite data table memory 130 of hearing aid 100 of FIG. 1A.

Controller and DSP 230 runs programs that determine what data is written to data table memory 130 in order to program hearing aid 100. Then controller and DSP 230 sends audio test sounds to speaker 204 using speaker connection 205. Hearing aid 100, via its DSP 103, processes the test sounds and emits them from its own output speaker 105. These sounds are received by microphone 203 and are sent through connection 206 back to controller and DSP 230. The testing process continues as controller and DSP 230 sends out its entire series of test sounds and receives the entire series back. Controller and DSP 230 compares the actual test results with the expected test results, and diagnoses the status of hearing aid 100. This status is sent to light panel 215 through connector 216, and indicator lights 210, 211, 212 and 214 provide messages such as “Power on,” “Service hearing aid,” and “Passed test,” as appropriate to the test results.

It should be noted that a program to debug test device 200 could be run without hearing aid 100 in test device 200 to ensure that test device 200 is working properly.

In an alternative mode, test device 200 can be used as a storage unit for hearing aid 100. For example hearing aid unit 100 can be switched off and placed inside test device 200, which is sealed out by replacing the ambient air with a storage gas such as Nitrogen or Carbon Dioxide. This sealing and storing technique is well known in the art.

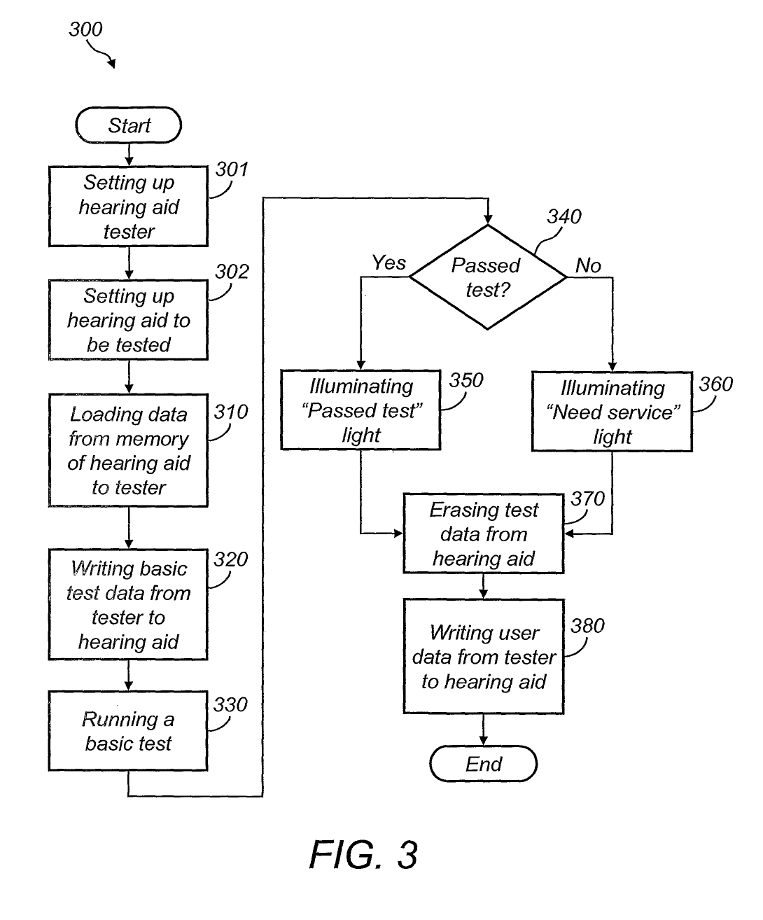

FIG. 3 is a method 300 for testing hearing aids such as hearing aid 100 of FIG. 1A using an at-home routine automatic hearing aid tester that generates test tones, including the steps of:

Step 301: Setting Up Hearing Aid Tester

In this step, test device 200 of FIG. 2 is turned on. A debug test is run with the unit closed and no hearing aid 100 in the device to ensure that test device 200 is working properly. Top 201 is opened.

Step 302: Setting Up Hearing Aid to be Tested

In this step, hearing aid 100 is removed from the user's ear, is turned on (if not already on), and is placed into test device 200. Hearing aid 100 is then automatically calibrated, i.e. the audible sound receiving sensitivity of microphone 101 and output amplitude of speaker 105 are set to an optimal level for conducting the test. Methods of automatic calibration of hearing aid 100 are well known in the art, and those skilled in the art can easily suggest a known method for this step. If necessary, optional adapter 250 is used to ensure proper fit. Top 201 is closed.

Step 310: Loading Data from Memory of Hearing Aid to Tester

In this step, test device 200 automatically downloads programming data from memory 107 of hearing aid 100, storing the data in test device 200 to clear memory 107 in preparation for the diagnostic hearing aid test of the present invention.

Step 320: Writing Basic Test Data from Tester to Hearing Aid

In this step, basic test data is written from test device 200 to memory 107 in preparation for the diagnostic hearing test.

Step 330: Running Basic Test

In this step, the user initiates the test program, or alternatively the test program is automatically performed following Step 320, which sends sounds (tones) at various amplitudes directly from controller and DSP 230 of test device 200 to speaker 204. These tones are then received by microphone 101 of hearing aid 100, output through output speaker 105, then collected by microphone 203 of test device 200 and conveyed as test results to controller and DSP 230.

Step 340: Passed Test?

In this decision step, the test results are compared with standard hearing aid data stored in test device 200 to determine whether hearing aid 100 is functioning as intended when optimized for the user. This comparison step may be performed by a computer algorithm that compares a test result, such as a given frequency and amplitude, with the expected result, then calculates whether the test result is within tolerance. If hearing aid 100 is functioning within tolerance, method 300 proceeds to step 350; if not, method 300 proceeds to step 360.

Step 360: Illuminating “Passed Test” Light

In this step, controller and DSP 230 sends a signal to light panel 215 to illuminate indicator light 214 that indicates that hearing aid 100 has passed the test. Method 300 proceeds to step 370.

Step 360: Illuminating “Need Service” Light

In this step, controller and DSP 230 sends a signal to light panel 215 to illuminate indicator light 210 that indicates that hearing aid 100 needs service. This signals the user to seek professional maintenance of hearing aid 100 and test device 200 once method 300 is complete. In one embodiment, test device 200 can be connected to a system (not shown) that can directly notify an interested stakeholder or a hearing health professional if hearing aid 100 needs services. This can further prompt the hearing health professional to preemptively contact the user and suggest that the user visit the hearing health professional. The hearing health professional would then assess both hearing aid 100 and test device 200 and perhaps also the user's hearing, recommending remedial action. Method 300 proceeds to step 370.

Step 370: Erasing Test Data from Hearing Aid

In this step, test device 200 erases the test data from memory 107 of hearing aid 100.

Step 380: Writing User Data from Tester to Hearing Aid

In this step, test device 200 writes the user's programming data stored in test device 200 in step 370 back into memory 107 of hearing aid 100. Method 300 ends.

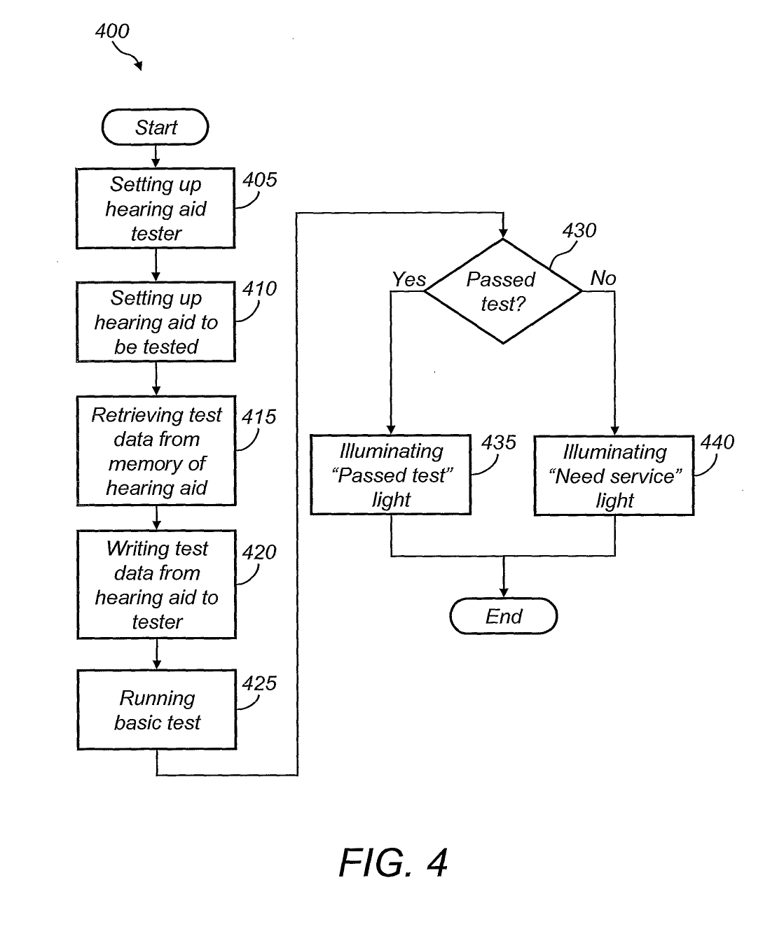

FIG. 4 is a method 400 for testing hearing aids using the at-home routine automatic hearing aid with tones generated by the hearing aid, including the steps of:

Step 405: Setting Up Hearing Aid Tester

In this step, test device 200 of FIG. 2 is turned on. A debug test is run with the unit closed and no hearing aid 100 in the device to ensure that test device 200 is working properly. Top 201 opened.

Step 410: Setting Up Hearing Aid to be Tested

In this step, hearing aid 100 is removed from the user's ear, is turned on (if not already on), and is placed into test device 200. Hearing aid 100 is then automatically calibrated, i.e. the volume of microphone 101 and output speaker 105 are set to an optimal level for conducting the test. Methods of automatic calibration of hearing aid 100 are well known in the art, and those skilled in the art can easily suggest a known method for this step. If necessary, optional adapter 250 is used to ensure proper fit. Top 210 is closed.

Step 415: Retrieving Test Data from Memory of Hearing Aid

In this step, hearing aid 100 is initialized by controller and DSP 230, which causes hearing aid 100 to automatically generate tones and retrieve other user-personalized programming data from memory 107 in preparation for the diagnostic hearing aid test that has been optimized for the individual user.

Step 420: Writing Test Data from Hearing Aid to Tester

In this step, test data retrieved in step 415 is written from memory 107 of hearing aid 100 to test device 200 in preparation for the diagnostic hearing test.

Step 425: Running Basic Test

In this step, the user initiates the test program. The test program sends sounds (tones) at various amplitudes directly from output speaker 105 of hearing aid 100. The sounds are received by microphone 203 of test device 200 and sent to controller and DSP 230.

Step 430: Passed Test?

In this decision step, the test results are compared with standard-hearing aid data stored in test device 200 to determine whether hearing aid 100 is functioning as intended when optimized for the user. This comparison step may be performed by a computer algorithm that compares a test result, such as a given frequency and amplitude, with the expected result, then calculates whether the test result is within tolerance. If hearing aid 100 is functioning within tolerance, method 400 proceeds to step 435; if not, method 400 proceeds to step 440.

Step 435: Illuminating “Passed Test” Light

In this step, controller and DSP 230 sends a signal to light panel 215 to illuminate indicator light 214 that indicates that hearing aid 100 has passed the test. Method 400 ends.

Step 440: Illuminating “Need Service” Light

In this step, controller and DSP 230 sends a signal to light panel 215 to illuminate indicator light 210 that indicates that hearing aid 100 needs service. This signals the user to seek professional maintenance of hearing aid 100 and test device 200 once method 400 is complete. In one embodiment, test device 200 can be connected to a system (not shown) that can directly notify a hearing health professional if hearing aid 100 needs services. This can further prompt the hearing health professional to preemptively contact the user and suggest that the user visit the hearing health professional. The hearing health professional would then assess both hearing aid 100 and test device 200 and perhaps also the user's hearing, recommending remedial action. Method 400 ends.

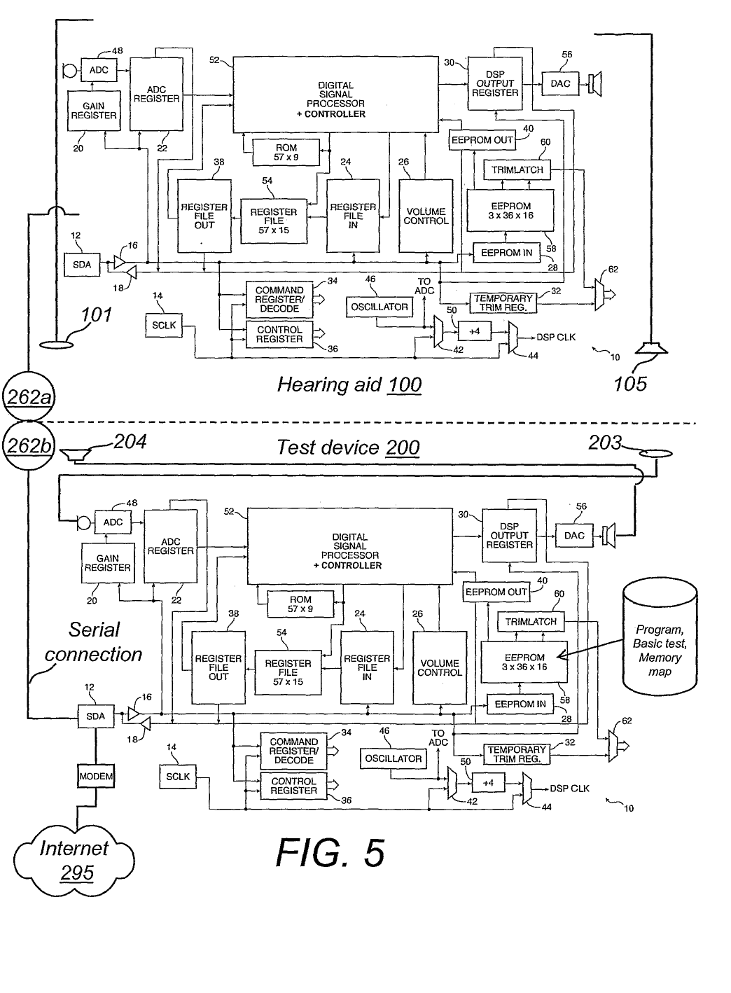

FIG. 5 is a block diagram showing the portions of hearing aid 10 (e.g., basic hearing aid 100 of FIG. 1A) including the serial interface, as explained as FIG. 1B. FIG. 5 shows the physical arrangement of hearing aid 100 (the top section of the diagram) and test device 200 (the bottom section of the diagram). In addition, FIG. 5 shows a physical connection for diagnostic testing data interchange between serial connector 262a of hearing aid 100 and serial connector 262b of test device 200. The program, basic test, and memory map are stored in EEPROM 58 of test device 200.

Microphone 101 of hearing aid 100 is shown opposite speaker 204 of test device 200. Microphone 203 of test device 200 is shown opposite output speaker 105 of hearing aid 100. Serial connectors 262a and 262b are physically connected.

In this manner, an at-home diagnostic hearing aid testing and maintenance process can be performed. The diagnostic test is automatic and convenient, and can be conducted as frequently as daily. The diagnostic test provides updates on the status of the hearing aid status, such as “improper functioning” or “service required”.

Although preferred embodiments of the present invention have been described and illustrated, it will be apparent to those skilled in the art that various modifications may be made without departing from the principles of the invention.

What is claimed is:

1. A portable hearing aid testing apparatus comprising:
a resealable housing defining a cavity for receiving a hearing aid, wherein the cavity comprises a microphone and has a configuration for securing the hearing aid in a position where a speaker of the hearing aid is situated opposite of the microphone;
a communications interface means for coupling to a data signal connection means of the hearing aid; and
a controller coupled to the communications interface means, the microphone and an indicia output means, wherein the controller is operable for testing the operation of the hearing aid.

2. The apparatus of claim 1, wherein the communications interface means is a communications network interface for receiving hearing aid testing and programming data and for transmitting user hearing aid profile data to a remote hearing health database.

3. The apparatus of claim 2, wherein the communications network interface is a computer capable of connecting to the internet.

4. The apparatus of claim 1, wherein the hearing aid is programmable based on receipt of a corrective sound signal, wherein the controller, based on the hearing aid programming data received from a health database, causes the speaker to generate the corrective sound signal.

5. The apparatus of claim 1, wherein the controller comprise a memory for storing the hearing aid programming data and the hearing aid testing data.

6. The apparatus of claim 1, wherein the indicia output means is an indicator light.

7. A method for testing the operation of a hearing aid, said method comprises:
transmitting testing data from a controller to cause the hearing aid to generate a sound output;
receiving the sound output at a microphone and forwarding sound data signals representative of the sound output to the controller;
evaluating the sound data signals to determine whether frequencies and amplitudes of the sound signals correspond to expected frequencies and amplitudes associated with the testing data; and
generating a selected indicia for output at an indicia output means.

8. The method of claim 3, wherein the data is transmitted to the hearing aid or to a speaker within a cavity of a resealable housing.

9. The method of claim 3, wherein the selected indicia for output is a pass or fail of a clean hearing aid.
